(19) United States
(12) Patent Application Publication
(10) Pub. No.: US 2023/0213100 A1
(43) Pub. Date: Jul. 6, 2023

(54) Actuator for Gate Valve and Method of Attachment

(71) Applicant: SPM Oil & Gas Inc., Fort Worth, TX (US)

(72) Inventors: Jarryd B. Daniels, Houston, TX (US); Dennis D. Lam, Houston, TX (US)

(73) Assignee: SPM Oil & Gas Inc., Fort Worth, TX (US)

(21) Appl. No.: 17/566,034

(22) Filed: Dec. 30, 2021

(51) Int. Cl. F16K 3/02; F16K 3/312; F16K 3/314; F16K 27/04; F16K 31/05; F16K 37/00

(52) U.S. Cl. CPC F16K 3/0254; F16K 3/0281; F16K 3/312; F16K 3/314; F16K 27/044; F16K 31/05; F16K 37/0008; F16K 37/0041; F16K 37/0083

(57) ABSTRACT

An assembly for actuating a gate valve. The assembly includes an actuator and a bonnet adapter and stem adapter. The assembly includes a bonnet adapter configured to attach to the actuator and configured to attach to a bonnet of the gate valve. An actuator stem is attached to the actuator and extends at least in part into the bonnet adapter. A stem adapter is configured to be positioned within the bonnet adapter and attach to the actuator stem and to a gate valve stem. The bonnet adapter further includes access windows for accessing the stem adapter and the bonnet adapter is configured to permit the actuator stem and stem adapter to move axially therewithin.

### TECHNICAL FIELD

The present disclosure relates to actuators for opening and closing valves, such as gate valves and methods of assembling such an actuator.

### BACKGROUND

Valves, and in particular, gate valves, such as those used in challenging environments like hydraulic fracking operations, are typically opened and closed manually. Manual mechanisms are simple to use and inexpensive to manufacture. However, such environments may expose operators to potentially dangerous high pressure fluids, machinery, and requires proximity to potentially dangerous liquid chemicals and gases.

Non-manual means of opening and closing gate valves have been made. However, the attachment of such devices can be challenging and may be less reliable than is desired. U.S. Pat. No. 9,091,351 discusses a mechanism for operating a gate valve, including a hand-wheel attached to a first valve stem and which rotates within a ball-screw drive assembly to raise and lower the first valve stem and a gate within a bonnet and gate cavity. The hand-wheel and ball-screw drive assembly are connected to the non-rotating first valve stem. The mechanical actuation mechanism is disposed on the bonnet by a bearing cap, which engages with a threaded bonnet top to position and retain the mechanical actuation mechanism in the gate valve system. The document notes that the mechanical actuation mechanism can be replaced by a hydraulic drive actuation mechanism, a motor actuation mechanism, or some other means to move the first and second valve stems and the gate within the gate cavity. However, the document provides no insights regarding how such a mechanism would be constructed or attached to the gate valve.

There is a demand for a remotely operated and/or controlled gate valve actuation mechanism with a reliable method for attaching and removing such a mechanism to a valve body. The present disclosure addresses the demand.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, the disclosure includes an assembly for actuating a gate valve. The assembly includes an actuator, a bonnet adapter, and a stem adapter. The bonnet adapter is configured to attach to the actuator and configured to attach to a bonnet of the gate valve. An actuator stem is attached to the actuator and extends at least in part into the bonnet adapter. A stem adapter is configured to be positioned within the bonnet adapter and attach to the actuator stem and to a gate valve stem. The bonnet adapter further includes access windows for accessing the stem adapter and the bonnet adapter is configured to permit the actuator stem and stem adapter to move axially therewithin.

In another aspect the disclosure includes a gate valve and system for operating the gate valve, wherein the gate valve comprises: a housing comprising an inlet, an outlet, and a bonnet; a gate disposed within the housing and configured to open to permit flow from the inlet to the outlet and close to block flow. A gate valve stem is attached to the gate. The gate valve stem extends outwardly from the bonnet. The system includes an actuator and a bonnet adapter and stem adapter. The bonnet adapter is configured to attach to the actuator and configured to attach to the bonnet. An actuator stem attaches to the actuator and extends at least in part into the bonnet adapter. A stem adapter is configured to be positioned within the bonnet adapter and attach to the actuator stem and to the gate valve stem. The bonnet adapter further includes access windows for accessing the stem adapter and the bonnet adapter is configured to permit the actuator stem and stem adapter to move axially therewithin.

In yet another aspect, the disclosure includes a method of attaching a stem adapter to a threaded gate valve stem of a gate valve. The stem adapter is threaded to the gate valve stem. A bonnet adapter is attached to a bonnet of the gate valve by a threaded connection. An actuator stem may be attached to the actuator by the stem adapter via a pin. The bonnet adapter is attached to the actuator, for example by fasteners, thereby mounting the actuator to the bonnet of the gate valve. The gate valve is operated via the actuator through linear movements of the actuator and through the connection of the actuator stem to the gate valve stem and thereby the gate.

### BRIEF DESCRIPTION OF THE DRAWINGS

FIGS. 1 and 2 are simplified illustrations of a prior art gate valve and manually operated screw mechanism to open and close the valve.

FIG. 3 is a schematic of a gate valve, actuator, and attachment assembly, and associated elements.

FIG. 4 is a cross section view of an actuator and attachment assembly for operating a valve.

FIG. 5 is the actuator and attachment assembly of FIG. 4 attached to a gate valve in an open condition.

FIG. 6 is the actuator and attachment assembly of FIG. 4 attached to a gate valve in a closed condition.

FIG. 7 is a flowchart of a method of attaching an actuator to a gate valve.

### DETAILED DESCRIPTION

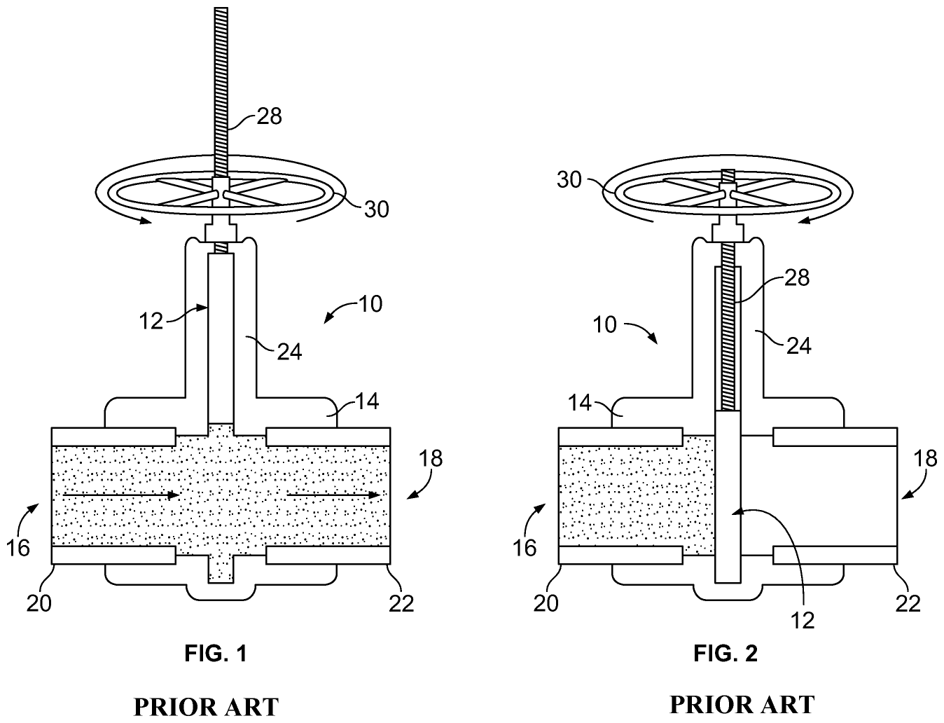

Now referring to the drawings, wherein like elements refer to like reference numbers, there is illustrated in FIGS. 1 and 2 an exemplary and simplified prior art valve 10 with a manually operated gate 12. The illustrated valve 10 is a gate valve, however, a gate valve is shown primarily for illustrative purposes to assist in providing context for various embodiments of the disclosure and it will be understood that devices and methods according to embodiments of this disclosure can be employed on other similar devices with similar requirements.

FIG. 1 shows that the valve 10 includes a housing 14, which includes an inlet side 16 and an outlet side 18 depending on the flow of fluid and other materials through the valve. The inlet side 16 and outlet side 18 are configured to attach to conduits 20, 22, which may be in the form of cylindrical pipes. The housing 14 includes a bonnet 24 which is configured to attach to the housing 14 or may be formed integral with the housing. The bonnet 24 is configured to receive the gate 12. The gate 12 is attached to a threaded rod 28. The threaded rod 28 is engaged with a hand wheel 30 and rotation of the hand wheel causes the rod to advance into and out of the bonnet 24 as is known. The gate 12 attached to the rod 28, is movable into an open condition shown in FIG. 1 wherein the gate 12 is raised into the bonnet 24 and enables flow to enter the inlet side 16, flow through the valve housing 14, and flow to exit via the outlet side 18 via manual rotation of the hand wheel 30. The gate 12 is shown in the closed condition in FIG. 2, wherein flow through the valve 10 is blocked by the gate sealingly occupying a position between the inlet side 16 and the outlet side 18.

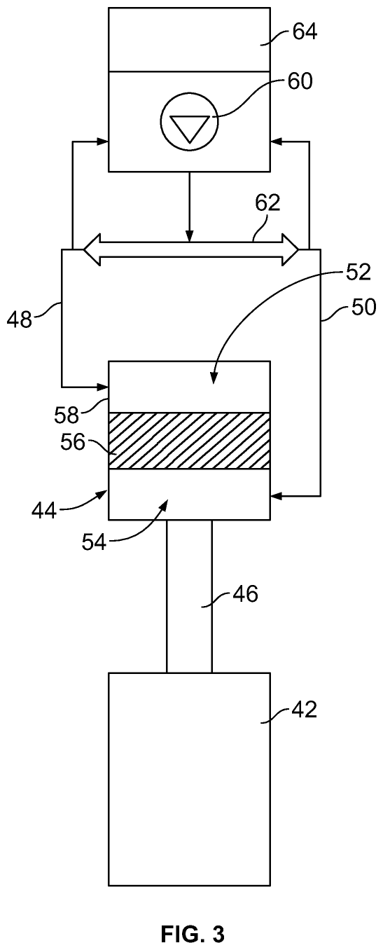

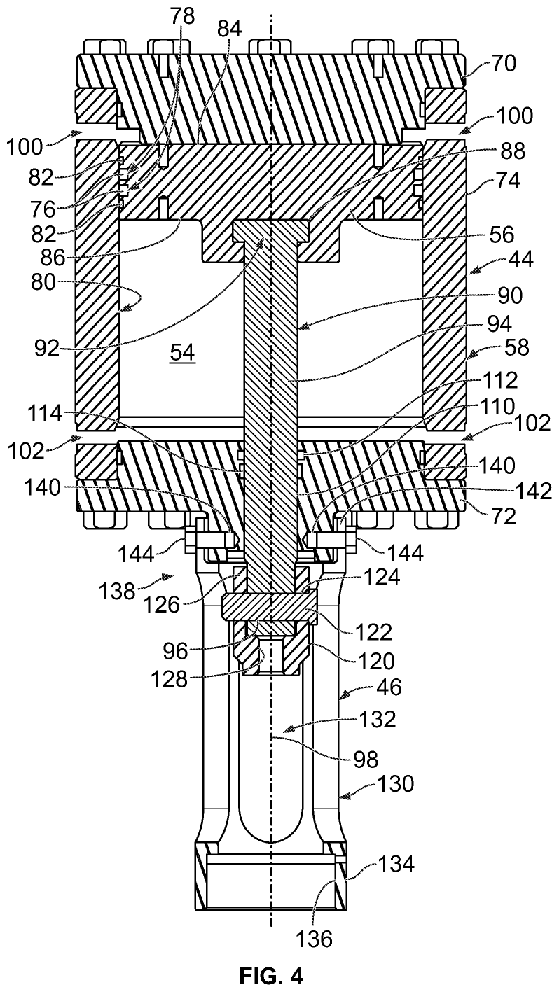

FIG. 3 illustrates a system 40 for operating a gate valve, or the like, that does not require manual operation according to embodiments. A conventional gate valve 42 is connected to an actuator 44, which in the instant example is a double-acting actuator, by way of a bonnet adapter and stem adapter assembly 46, which will be discussed in detail with respect to FIG. 4. The disclosure contemplates any suitable actuator that produces a generally linear motion via fluid pressure, electrical or mechanical means, for example.

The actuator 44 in embodiments is supplied fluid by way of at least two fluid conduits 48, 50. A first one of the conduits 48 is fluidly connected to the actuator 44 and is configured to supply fluid to a first chamber 52 of the actuator. A second one of the conduits 50 is fluidly connected to the actuator 44 and is configured to supply fluid to a second chamber 54 of the actuator. The first and second conduits 48, 50 may comprise one or more pipe, tube, or the like. In embodiments, each of the first and second conduits 48, 50 includes two fluid pipes.

The first and second chambers 52, 54 are separated by a piston 56, which is movably disposed within and sealingly engaged with a fluid cylinder 58 defined within the actuator 44. Fluid, which may be hydraulic fluid, or any suitable fluid, is supplied to the conduits 48, 50 with a fluid pump 60. A switch 62 may be used between the fluid pump 60 and the conduits 48, 50 to direct the flow of fluid into either one of the conduits depending on the desired result of moving the piston 56, the effects of which will be explained hereinbelow.

The pump 60 and switch 62 may be in communication with a controller 64, which may be any controller that is configured to operate in a logical fashion to perform operations, execute control algorithms, store and retrieve data, and/or perform other desired operations. The controller 64 may include or may access memory, secondary storage devices, processors, and any other components for running at least one application. The memory and secondary storage devices may be in the form of read-only memory (ROM) or random-access memory (RAM) or integrated circuitry that is accessible by the controller. Various other circuits may be associated with the controller 64 such as power supply circuitry, signal conditioning circuitry, driver circuitry, and other types of circuitry. The controller 64 may be a single controller or may include more than one controller disposed to control various functions and/or features of the pump 60 and switch 62. The term “controller” is meant to be used in its broadest sense to include one or more controllers and/or microprocessors that may be associated with the pump 60 and switch 62 and that may cooperate in controlling various functions and operations of the system 40. The functionality of the controller 64 may be implemented in hardware and/or software without regard to the functionality. Alternatively, the controller may be a mechanism as simple as a button, switch, or the like, which may be positioned remotely from the valve 42 such that an operator is not required to physically be near the valve.

Briefly, in use, when the piston 56 is moved downwardly (according to the orientation of elements in the figure) by fluid entering chamber 52, the gate valve 42 is closed and when the piston is moved up (according to the orientation of elements in the figure) by fluid entering chamber 54 the gate valve is opened. The structural basis for the opening and closing functionality of the system is explained in the following.

Turning to FIG. 4 a double-acting actuator 44 and a bonnet adapter and stem adapter assembly 46 according to embodiments are shown. Referring to elements according to the orientation of the elements in the figure, the actuator 44 includes a fluid cylinder 58 in which a piston 56 is movably and sealingly disposed. The fluid cylinder 58 includes a cap 70, a base 72, and a sleeve 74 positioned between and attached to the cap and base.

The cap 70 is positioned on top of the sleeve 74 and may be attached thereto by bolts or screws, for example, and therefore located distally relative to the base 72 and gate valve (see FIG. 3). The base 72 is attached at an opposite end of the sleeve 74 relative to the cap 70. The cap 70 and base 72 when attached to the sleeve 74 form a cylindrical chamber which is fluidly divided into a first fluid chamber 52 (see FIG. 3) defined between the piston 56 and the cap 70 and a second fluid chamber 54 defined between the piston and the base 72.

The sleeve 74 includes one or more first fluid passages 100 in communication with the first fluid chamber 52 (see FIG. 3) and one or more second fluid passages 102 in communication with the second fluid chamber 54. Referring also to FIG. 3, the first fluid passages 100 are fluidly connected to the first conduit 48 and the second fluid passages 102 are fluidly connected to the second conduit 50. When the pump 60 sends fluid into the first conduit 48, fluid enters the first fluid passages 100 and enters the first fluid chamber 52, which in turn urges the piston 56 downwardly. When the pump 60 sends fluid into the second conduit 50, fluid enters the second fluid passages 102 and enters the second fluid chamber 54, which in turn urges the piston 56 upwardly.

The piston 56 is a cylindrical sealing and movable part disposed in the sleeve 74. The piston 56 is provided with one or more annular piston seal members 76, which may be in the form of O-rings or any suitable seal configuration. The piston seal members 76 may be circular or rectangular in cross section and may be made of a suitable elastomeric material. The piston seal members 76 fit to annular channels 78 formed about the circumference of the piston 56 and are configured to protrude slightly therefrom to contact the inner wall 80 of the sleeve 74 when the piston 56 is inserted into the sleeve and form a seal between the piston and the sleeve. The seal members 76 may be a two-piece combination of a circular seal and a rectangular seal. In addition, wear rings 82 may be similarly positioned on the outer circumference of the piston 56. The wear rings 82 may be formed of any suitable metallic and/or composite material and may be generally rectangular in cross section. The wear rings 82 may be a pair of rings, each of which is positioned axially outside the seal members 76 at a respective outer end 84 and an inner end 86 of the piston 56.

The piston 56 also includes, on the inner end 86 of the piston, a t-slot 88. The t-slot 88 is accessible from either side of the slot and is shaped and sized to retain a correspondingly shaped piece, which will be referred to as an actuator stem 90.

The actuator stem 90 has a T-shaped head portion 92, which is shaped and sized to be received within the t-slot 88, and thereby secured to the piston 56. The actuator stem 90 includes an elongate, rod-shaped portion or shaft 94. The shaft 94 passes through a base hole 110, formed through the base 72 and about an actuator axis 98. The base 72 includes a seal 112, which may be an elastomeric seal material, and a wear ring 114, which may be a metallic. The seal 112 and wear ring 114 bear against the shaft 94 and prevent loss of fluid from chamber 54. The shaft 94 opposite the T-shaped head 92 includes a stem hole 96 that is formed through the shaft and normal to the actuator axis 98.

A stem adapter 120 is attachable to the shaft 94 via a pin 122 that passes through a stem adapter hole 124 and the stem hole 96. The stem adapter 120 has a stem receiving cup 126 at one end thereof, which is shaped and sized to receive the shaft 94. Opposite the stem receiving cup 126 is a threaded bore 128. The threaded bore 128 of the stem adapter 120 is configured to attach to a threaded gate valve stem or threaded rod 28 (see FIG. 1).

The actuator 44 is attached to the gate valve 42 by way of the bonnet adapter and stem adapter assembly 46, which, in addition to the actuator stem 90, stem adapter 120 and pin 122, includes a bonnet adapter 130. The bonnet adapter 130 is generally a hollow tube with access windows 132 formed in the sides thereof to permit access to the interior of the bonnet adapter. The bonnet adapter 130 is sized and shaped to permit axial movement of the stem adapter 120 and the actuator stem 90 therein.

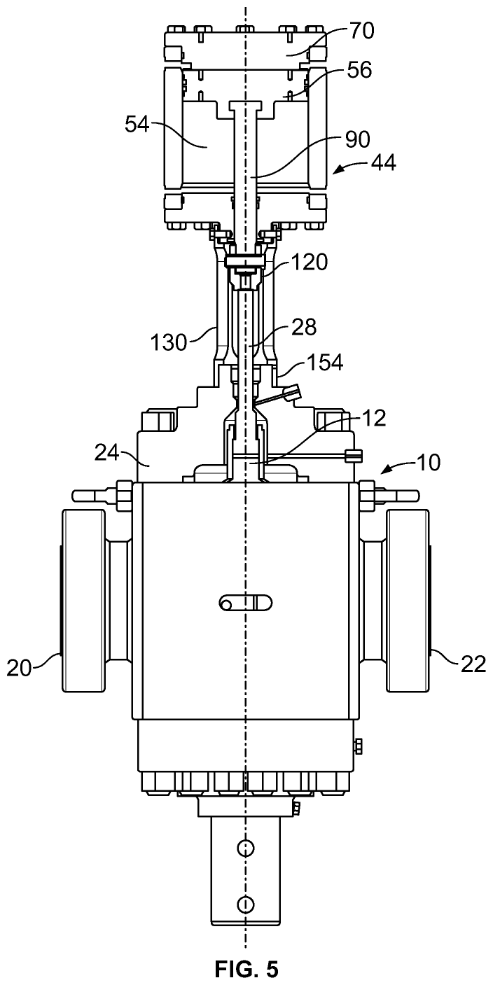

At a valve end 134 of the bonnet adapter 130 a threaded socket 136 is formed that is sized and shaped to fit over a corresponding part of the valve bonnet (see FIG. 5) for securing the bonnet adapter thereto. At an end opposite the valve end 134, i.e., the actuator end 138, a plurality of threaded holes 140 are formed in an actuator socket 142, which are sized and shaped to each receive a fastener 144, which may be a bolt or any suitable fastener.

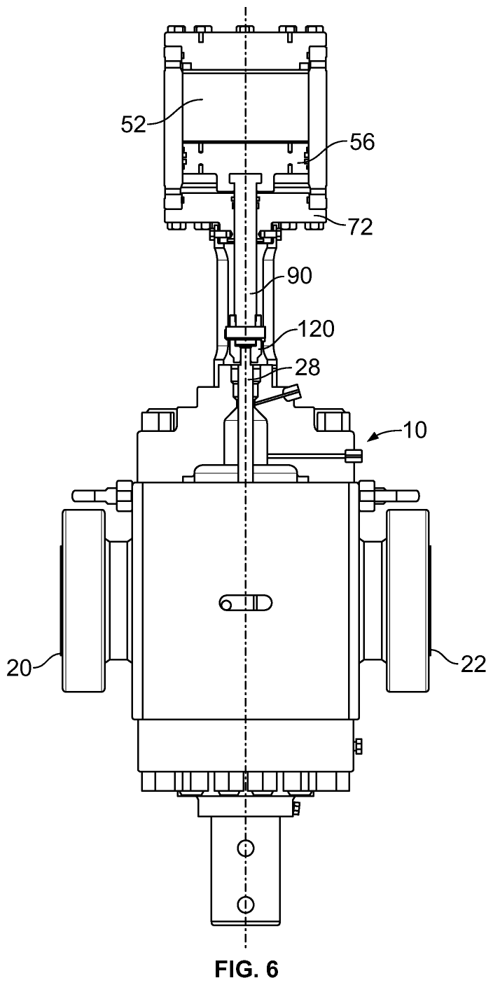

FIGS. 5 and 6 respectively show the actuator 44 and valve 10 in an open condition (FIG. 5) and in a closed condition (FIG. 6). The illustrated configuration is referred to as standard-acting. In other embodiments, a reverse-acting configuration is contemplated. In FIG. 5 fluid pressure in second chamber 54 urges piston 56 in the direction of the cap 70. Movement of the piston 56 pulls actuator stem 90 upwardly (outwardly relative to the valve 10). Movement of the actuator stem 90 via the pinned connection to the stem adapter 120 pulls a gate valve stem 28 and moves the gate 12 into an open condition permitting flow through the valve 10 from the inlet 16 to the outlet 18. FIG. 5 also shows the threaded connection 156 of the bonnet adapter 130 to the valve bonnet 24, which holds the actuator 44 to the valve 10.

Conversely, in FIG. 6, fluid pressure in first chamber 52 urges piston 56 in the direction of the base 72. Movement of the piston 56 pushes actuator stem 90 downwardly (inwardly relative to the valve 10). Movement of the actuator stem 90 via the pinned connection to the stem adapter 120 pushes the gate valve stem 28 and moves the gate valve (not shown) into a closed condition preventing flow through the valve 10 from the inlet 20 to the outlet 22.

### INDUSTRIAL APPLICABILITY

The industrial applicability of the system described herein will be readily appreciated from the forgoing discussion. The foregoing discussion is applicable to machines that are lifted into a work site.

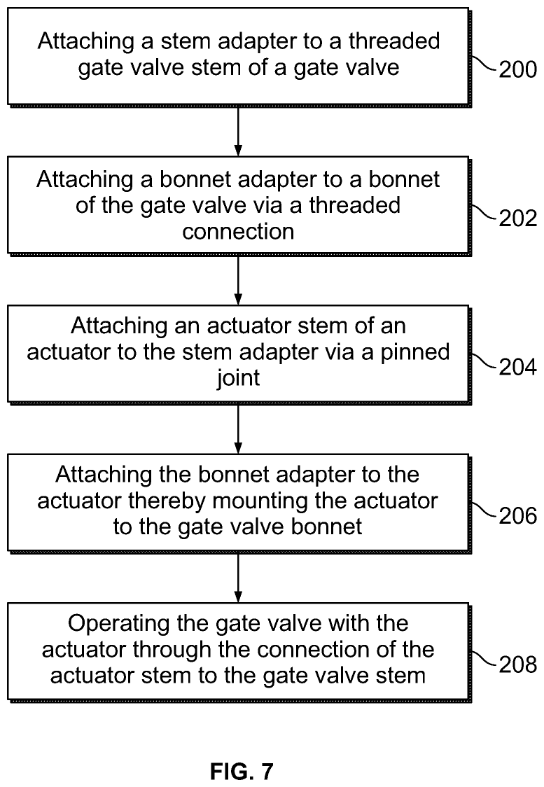

One example of industrial applicability according to the disclosure, in operation, illustrates a method of assembling an actuator as shown in FIG. 7. Also referring to the other figures, the method includes attaching a stem adapter 120 to a threaded gate valve stem 28 of a gate valve 10 (step 200). The stem adapter 120 is threaded to the gate valve stem. A bonnet adapter 130 is attached to a bonnet 24 of the gate valve 10 by a threaded connection 156 (202). An actuator stem 90 is attached to the actuator 44 by the stem adapter 120 via a pin 122 (204). The bonnet adapter 130 is attached to the actuator, for example by fasteners 144, thereby mounting the actuator to the bonnet 24 of the valve 10 (206). The gate 12 is operated via the actuator through linear movements of the actuator and through the connection of the actuator stem 90 to the gate valve stem 28 and thereby the gate 12 (208). It will be understood that the order of some of the connections may be varied from the above.

Further, the disassembly of the actuator 44 from the valve 10 may proceed in the reverse order. Because the actuator 44 can be connected to the valve both structurally and functionally without disassembling the housing and conversely removed from the valve without disassembling the housing of the actuator, installing or replacing the actuator can proceed quickly and simply according to the above method.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An assembly for actuating a gate valve, comprising:
an actuator;
a bonnet adapter configured to attach to the actuator and configured to attach to a bonnet of the gate valve;
an actuator stem attached to the actuator and extending at least in part into the bonnet adapter; and
a stem adapter configured to be positioned within the bonnet adapter and attach to the actuator stem and to a gate valve stem,
wherein the bonnet adapter includes:
access windows for accessing the stem adapter, and
a threaded socket configured to attach the bonnet adapter to the bonnet of the gate valve, and
wherein the bonnet adapter is configured to permit the actuator stem and stem adapter to move axially therewithin.

2. The assembly of claim 1,
wherein the actuator comprises a housing and a movable piston disposed in the housing, and
wherein the actuator is configured to be detached from the gate valve stem without disassembling the housing.

3. The assembly of claim wherein the actuator is a double-acting actuator that includes a piston movably disposed in the double-acting actuator.

4. The assembly of claim 3, wherein the actuator stem is configured to attach to the piston.

5. The assembly of claim 4, wherein the piston includes a t-slot and the actuator stem is configured to attach to the t-slot of the piston.

6. The assembly of claim 3,
wherein the piston defines a first chamber and a second chamber,
wherein fluid pressure entering the first chamber moves the actuator stem out of the actuator, and
wherein fluid pressure entering the second chamber moves the actuator stem into the actuator.

7. The assembly of claim 6, wherein the actuator is in communication with a fluid pump via at least one first conduit that is in communication with the first chamber and at least one second conduit that is in communication with the second chamber.

8. The assembly of claim 1, wherein the bonnet adapter attaches to the actuator via a plurality of fasteners.

9. (canceled)

10. The assembly of claim 1, wherein the stem adapter attaches to the actuator stem via a pin.

11. The assembly of claim 1, wherein the stem adapter includes a threaded bore configured to attach the stem adapter to the gate valve stem.

12. A system, comprising:
a housing comprising an inlet, an outlet, and a bonnet;
a gate disposed within the housing and configured to open to permit flow from the inlet to the outlet and close to block flow;
a gate valve stem attached to the gate,
the gate valve stem extending outwardly from the bonnet;
an actuator configured to open and close the gate;
a bonnet adapter configured to attach to the actuator and configured to attach to the bonnet;
an actuator stem attached to the actuator and extending at least in part into the bonnet adapter;
a stem adapter configured to be positioned within the bonnet adapter and attached to the actuator stem and to the gate valve stem,
wherein the bonnet adapter includes:
access windows for accessing the stem adapter, and
a threaded socket configured to attach the bonnet adapter to the bonnet, and
wherein the bonnet adapter is configured to permit the actuator stem and stem adapter to move axially therewithin.

13. The system of claim 12, wherein the gate valve stem is threaded.

14. The system of claim 12, wherein the actuator is a double-acting actuator.

15. The system of claim 14, wherein the double-acting actuator includes a piston movably disposed in the double-acting actuator.

16. The system of claim 15, wherein the actuator stem is configured to attach to the piston.

17. The system of claim 16, wherein the piston includes a t-slot and the actuator stem is configured to attach to the t-slot of the piston.

18. The system of claim 12, wherein the bonnet adapter attaches to the actuator via a plurality of fasteners.

19. The system of claim 12,
wherein the actuator comprises an actuator housing and a movable piston disposed in the actuator housing, and
wherein the actuator is configured to be detached from the gate valve stem without disassembling the actuator housing.

20. A method of attaching an actuator to a gate valve stem of a gate valve, comprising:
threading a stem adapter to the gate valve stem;
threading a bonnet adapter to a bonnet of the gate valve using a threaded socket of the bonnet adapter;
pinning together an actuator stem of the actuator to the stem adapter; and
fastening the bonnet adapter to the actuator, thereby mounting the actuator to the bonnet of the gate valve.

21. The method of claim 20, wherein the actuator is in communication with a fluid pump via:
at least one first conduit that is in communication with a first chamber of a piston of the actuator, and
at least one second conduit that is in communication with a second chamber of the piston.
